(19) United States
(12) Patent Application Publication
(10) Pub. No.: US 2016/0300506 A1
(43) Pub. Date: Oct. 13, 2016

(54) PERCEPTUAL STRESS TRAINING EYEWEAR PROVIDING RECOVERY PERIODS

(71) Applicant: Instinct Performance LLC, Oklahoma City, OK (US)

(72) Inventor: Alan Reichow, Cedar Falls, IA (US)

(73) Assignee: Instinct Performance LLC, Oklahoma City, OK (US)

(21) Appl. No.: 14/886,315

(22) Filed: Oct. 19, 2015

Related U.S. Application Data
(63) Continuation-in-part of application No. PCT/US2015/044124, filed on Aug. 7, 2015.
(60) Provisional application No. 62/065,263, filed on Oct. 17, 2014.

(51) Int. Cl. G09B 19/00; G09B 5/02

(52) U.S. Cl. CPC G09B 19/003; G09B 5/02

(57) ABSTRACT

Physical and/or sensory skills may be trained while an individual wears eyewear that alters the quality/quantity of visual information available to the individual. Sensor may measure performance metrics and/or physiological metrics during training During a recovery period, an individual may receive visual information with less alteration of the quality and/or quality of the information. The duration of the recovery period and/or the reduction in altering the quality and/or quantity of visual information provided during a recovery period may be determined based upon the performance metrics and/or the physiological metrics measured during training

### CROSS-REFERENCE TO RELATED APPLICATIONS

This application claims the benefit of provisional patent application Ser. No. 62/065,263, entitled “Perceptual Stress Training Eyewear Providing Recovery Periods,” filed on Oct. 17, 2014, which is incorporated herein by reference. This application also claims the benefit of international patent application PCT/US2015/044124, filed on Aug. 7, 2015, which is incorporated herein by reference.

### FIELD OF INVENTION

The present invention relates to systems and methods for training an individual's physical and sensory skills and abilities. More particularly, the present invention relates to systems and methods that selectively restrict the sensory information available to an individual during a training period and that provide a sensory recovery period to an individual after a training period, with the recovery period parameters based upon the individual's response to training.

### BACKGROUND AND DESCRIPTION OF THE RELATED ART

Typical day-to-day life requires a person to rely upon both sensory and physical abilities, typically in conjunction with one another. Competitive athletes may place greater demands upon their physical and sensory abilities than other individuals, but all individuals rely upon both sensory and physical abilities.

Successful athletes often possess innate physical abilities exceeding those of others, but mere physical ability, such as strength, speed, dexterity, and agility, is not usually enough to compete successfully at the highest level of a sport. Successful individuals must devote substantial time to training in order to improve their innate physical abilities and to develop specific skills needed to win in competition. Even non-athletes may engage in physical training for health benefits or simple pleasure. In some instances, however, individuals may engage in training to attempt to regain some or all of the abilities lost due to injury and/or illness. Success in athletics, and even day-to-day life for most people, requires more than mere physical skills, however. Physical skills do not exist in a vacuum. Any individual's physical skills are dependent upon the individual's sensory abilities for direction. Even an individual with exceptional strength, agility, or other physical skills will struggle if they lack the sensory skills to direct his or her physical actions.

### SUMMARY OF THE INVENTION

The present invention enables an individual's sensory abilities to be trained to a high level by providing a recovery period adapted to the individual's response to the sensory training. A training period that places a high amount of stress on an individual may be followed by a sensory recovery period sufficient to permit the individual to successfully train further. In some instances, a training session may be terminated entirely in order to permit an individual to recover from straining stress and/or to avoid discouraging the individual. Similarly, a training period that places little stress on an individual may be followed by little or no sensory recovery period. The stress placed upon an individual by sensory and/or physical training tasks during a training period may be measured using physiological and/or performance metrics obtained during a training period and/or during a recovery period.

While any person may find improved sensory abilities advantageous, affirmative sensory training and/or testing may be particularly valuable to anyone seeking to improve their performance in physical tasks. Some individuals seeking to improve their sensory abilities and associated physical performance abilities may be suffering from impairments, such as may be due to traumatic head injuries, stroke, or other illness or injury. For such individuals, improved abilities to integrate sensory data may greatly improve their quality of life. An individual with impaired balance, such as may be caused by traumatic head injuries, strokes, and other causes, may benefit from training to better integrate visual data with other senses to better walk, stand, and/or interact with his or her environment.

On the other hand, even individuals with relatively strong sensory skills may benefit from sensory training in order to improve a physical performance at least partially dependent upon those sensory abilities. For example, athletes and other individuals engaged in vocations and/or avocations with outcomes dependent in some way upon successfully interacting with the perceived environment may find their performance improved by engaging in sensory training. In athletic competition in particular, both athletic skill and sensory skills are required for success. Mere physical ability, such as strength, speed, dexterity, and agility, is not usually enough to compete successfully at the highest level of a sport. Successful athletes must devote substantial time to training in order to develop their innate abilities further and to develop specific skills needed to win in competition.

Systems and methods in accordance with the present invention enable sensory training to optionally occur as part of a physical training program pertinent to a particular activity, such as a sport or a rehabilitation process. Sensory skills do not typically exist in isolation. Individuals rarely wish to improve sensory skills, such as visual abilities, simply for the sake of improvement. Rather, individuals typically wish to improve sensory skills for a particular purpose. For example, a baseball player may wish to better identify a pitch type and location during a game; in competitive shooting, a Sporting Clays competitor may wish to improve her ability to track a rapidly moving target while maintaining a stable center of balance; a person recovering from a stroke may wish to regain a sense of balance sufficient to be able to walk with limited assistance. All of these examples, and many others, require a combination of sensory abilities and physical skills—both of which can be trained in accordance with the present invention. By incorporating sensory training into tasks involved, for example, with athletic training and/or physical therapy, systems and methods in accordance with the present invention improve both athletic/physical skills and sensory abilities/skills, while also developing sensory abilities/skills within the context of the activity of interest. By providing a recovery period during which the quality and/or quantity of visual information available to an individual are decreased less or not at all, an individual's tolerance for training can be increased, positive training practices can be reinforced, and/or negative training practices can be corrected. Recovery period parameters may be based upon the performance of an individual during training and/or the physiological response of an individual to training Examples of recovery period parameters that may be adjusted in accordance with the present invention are the quantity of sensory information provided during the recovery period, the quality of the sensory information provided during the recovery period, the duration of the recovery period, and/or the timing of the recovery period relative to training tasks.

### BRIEF DESCRIPTION OF THE SEVERAL VIEWS OF THE DRAWINGS

Examples of systems and methods in accordance with the present invention are described in conjunction with the attached drawings, wherein:

FIG. 1 schematically illustrates an exemplary system in accordance with the present invention;

FIG. 2 illustrates an example of an individual training using exemplary systems and methods in accordance with the present invention;

FIG. 3 schematically illustrates a further exemplary system in accordance with the present invention;

FIG. 4 illustrates an exemplary method in accordance with the present invention;

FIG. 5 illustrates a further example of an individual training using exemplary systems and methods in accordance with the present invention; and

FIG. 6 illustrates a further exemplary method in accordance with the present invention.

### DETAILED DESCRIPTION

The present invention provides systems and methods for training sensory abilities in conjunction with physical abilities. Sensory abilities may be trained by reducing the quantity and/or quality of sensory information available to an individual while the individual performs a training task during a training period. A training task may be related to a particular type of physical training, such as a sport or rehabilitative objective. Performance metrics describing the successful (or unsuccessful) completion of the task(s) performed may be measured using sensors in operable communication with a control unit that controls the quantity and/or quality of sensory information available to the individual training Additionally/alternatively, physiological metrics describing the condition of the individual performing the training task(s) may be measured by sensors in operable communication with the control unit. Based upon the performance metrics and/or physiological metrics for an individual performing the training task(s), the control unit may provide a sensory recovery period to the individual in which the quantity and/or quality of sensory information provided the individual is increased for a period of time. The time of the recovery period, the duration of the recovery period, and/or the increase in quantity/quality of sensory information provided during the recovery period may be determined based upon the performance and/or physiological metrics measured.

Systems and methods in accordance with the present invention enable individuals to improve their sensory abilities and to maximize those sensory abilities within a desired context. Some examples of contexts in which individuals may improve their sensory skills involve athletic competition. Some sensory challenges extend across a number of sports, such as the need to integrate visual information with an individual's balance and equilibrium. Other sensory challenges are unique to particular sports, such as the need to acquire a stationary target in shooting sports. Systems and methods in accordance with the present invention permit athletes to train their sensory skills within the context of physical tasks relevant to their sports.

Another example of contexts in which individuals may improve their sensory skills in accordance with the present invention is therapy programs. For example, individuals who have sustained an injury or suffered from illness may use systems and methods in accordance with the present invention as part of a rehabilitation process. Rehabilitation after a concussion or a stroke, for example, may involve training an individual to integrate his or her sensory perception in conjunction with performing physical tasks relevant to the individual's desired day-to-day life. The present invention permits an individual rehabilitating after a concussion, stroke, or any other injury or illness to train his or her sensory skills in conjunction with physical tasks that are useful in his or her rehabilitation.

In accordance with the present invention, non-sensory aspects of physical skills may optionally be developed or trained in conjunction with sensory training Sensory training in accordance with the present invention may comprise perceptual stress training that selectively limits the quantity and/or quality of sensory information available to the individual training The perceptual stress training may optionally be performed in conjunction with physical training tasks pertinent to a particular activity, such as a sport or an aspect of physical therapy. In some examples, however, tasks performed during perceptual stress training may be primarily or entirely selected to train the sensory abilities of the individual rather than to directly prepare the individual for a task pertinent to a particular activity. The difficulty of the task(s) performed during training, the amount of perceptual stress applied to an individual during training, and/or the parameters of the sensory recovery period provided after perceptual stress is applied may be varied based upon performance metrics indicative of an individual's performance in a training period and/or physiological metrics indicative of an individual's response to a training period.

By using sensors to measure the physical performance and/or physiological response of an individual during training, the recovery period parameters may be adjusted in order to maximize the benefit of the training without discouraging the individual. In many examples, sensory training in accordance with the present invention uses eyewear with one or more lens that controls and varies the quantity and/or quality of visual information available to the person wearing the eyewear. For example, the quantity and/or quality of visual information provided to the wearer of the eyewear may be altered by powering all or part of the material forming a lens(es) to cause the material to change in transparency or other optical property as the individual wearing the eyewear performs training tasks. A control unit may vary the sensory training based upon performance measurements and/or physiological measurements by adjusting the quantity and/or quality of visual information provided to the wearer and/or by providing instructions to the wearer via a display component that alters the physical training program to be executed by the wearer. Similarly, how a recovery period occurs, when a recovery period occurs, the quantity and/or quality of visual information provided during the recovery period, and/or how long a recovery period lasts may be adjusted based upon the performance metrics and/or physiological metrics of an individual undergoing sensory training

A variety of sensors may be used to detect or measure aspects of an individual's performance and/or physiological response to training Sensors may be integrated into a sensory training device (such as eyewear) in accordance with the present invention, but alternatively/additionally sensors may be located elsewhere on the individual or in the training facility while being in operable communication with the control unit via any communication protocol. Such a control unit may be integrated into eyewear in accordance with the present invention and/or may be in communication with the eyewear using any communication protocol and medium. Measurements made may comprise performance metrics and/or a physiological metrics. A performance metric may describe how well an individual has completed a training task while a physiological metric may describe the individual's response to the physical and sensory training For example, a performance metric may describe how many targets are hit during a shooting session while a physiological metric may describe the shooter's heart rate during the session. One or both of performance metrics and physiological metrics may be used to determine the sensory recovery period to provide an individual as part of training.

One example of possible performance sensors are position monitors, such as global positioning systems (GPS), that may be used to determine both the location of the individual at any given instant and to record a distance traveled or route covered by the individual during training While GPS typically requires that activities occur in an open space permitting the GPS device to receive signals from orbiting satellites, other positioning systems may use beacons or other sources at known locations (fixed or moving) to determine the location of a positioning system unit. Some positioning systems may use multiple cameras to locate an athlete during training and/or to track the movement of an individual during training, with a computing device executing instructions retained in a non-transitory medium combining the images from multiple cameras to locate an individual's position during the training

A performance metric may be measured by detecting the results of an individual's actions and/or by measuring the actions of an individual directly. For example, in shooting sports a sensor may detect vibrations (such as of the target itself or sound waves) indicating that a target has been hit. Camera based sensors, magnetic or electrical sensors, or any other type of sensor may be used to provide a metric descriptive of the success of a physical training task performed in conjunction with systems or methods in accordance with the present invention. Different types of performance metrics may be useful in conjunction with different types of training and, therefore, different types of sensors may be used for different types of training in accordance with the present invention.

Other examples of performance sensors are accelerometers, inertial sensors, pressure sensors, and/or force sensors that may be used to measure the movements, pressures, and/or forces generated by an individual during training and/or the stability or balance of an individual during training For example, pressure sensors and/or force sensors may be integrated with or inserted into shoes to measure pressure and/or force produced by the individual wearing the shoes, potentially both in terms of magnitude and direction. In some examples, an individual may stand on a platform or other device with pressure and/or force sensors integrated to perform a training exercise. Accelerometers and/or inertial sensors may be integrated into garments and/or equipment used for training, but additionally/alternatively may be detachably affixed to equipment, a garment, or the individual's body. By combining multiple sensors within a system, the movement of particular portions of an individual's body and parameters describing the individual's focus, stress, and other aspects of performance may be measured and/or detected. For example, pressure sensitive sensors integrated (permanently or temporarily) into shoes may provide stability data while accelerometers affixed to a person's arms may provide data describing the swing of a golf club, baseball bat, tennis racquet, a cane or other piece of equipment. Accelerometers or other types of sensors may be integrated into equipment as well. For example, a ball, bat, club, racquet, walking stick or other item of equipment may have sensors permanently or temporarily integrated with the equipment to measure its movement during training.

Performance data describing training and/or competitive success may also be measured using sensors. The relative success of a training exercise itself may be measured. For example, the accuracy of a rifle shot, the speed and/or accuracy of a baseball/softball pitch, the correct read of an American football defense by a practicing quarterback, the accuracy of a golf putt, the completion of a physical therapy exercise or the relative success in performing a training task may be measured and detected. In other examples, performance data may be based upon an input indicating the evaluation of an individual's performance by a trainer or coach, or even from the individual himself or herself.

In some examples, performance sensors may measure the movement of portions of an individual's body during training and/or the movement of equipment during training may be measured without the use of integrated sensors such as accelerometers. Motion capture systems may be used to record the movement of one or more part of a person's body and/or equipment used. In some examples, motion capture systems utilize markers affixed to the person and/or the equipment and one or more camera and an associated computing system executing computer readable code in a non-transitory form to detect those markers in space and track their movement. Other types of motion capture systems may not require any type of marker to be affixed in order to detect and measure motion. For example, some motion capture systems use multiple infrared sensors and/or laser sensors to detect the outline of a person's body and combine multiple infrared images in order to obtain a three dimensional representation of the person's body in space. Portions of the spectrum other than infrared, such as visible light, additionally/alternatively may be used in a motion capture system. Yet other types of motion capture systems may use beacons affixed to the person's body at desired anatomical locations and/or to equipment that transmit a signal that is detected and used to determine the location of that beacon at a given time and to detect the movement of that beacon through space over time.

A further example of a performance sensor(s) are eye tracking systems. Eye tracking systems may measure the movement of an individual's eyes and/or the focus of the individual's eyes during training Eye tracking systems may be integrated into eyewear or headwear worn during training, such as a visual training system that modifies the quantity and/or quality of visual information provided during sensory training, but may also be a separate system.

Physiological sensors may be used to measure aspects of an individual's physiology during physical and sensory training Measurements of an athlete's physiological response to training, or the response of a medical patient to training, may be an indication of the individual's performance, fitness level, cognitive stress, and/or attentional focus. For example, respiration rate, blood pressure, skin temperature, forces or pressures generated, perspiration rate, eyelid blink rate, electrodiagnostics, facial tension, palpebral fissure, or any other medical/biological parameter may be measured.

One example of a physiological metric that may be measured and used to adjust sensory recovery period parameters in accordance with the present invention is heart rate. A heart rate monitor may be used by an individual for training in accordance with the present invention. A measured heart rate may be used to quantify the exertion and/or stress placed on the individual by the physical and/or sensory training A target heart rate for an individual may be determined based upon prior measurements made for that individual, for example while performing the training tasks without restricting the quantity and/or quality of sensory information available to the individual. In some examples, a maximum desired heart rate may be set based upon a previously measured heart rate to prevent overtraining Similarly, other physiological metrics, such as blood pressure and/or galvanic skin response, may be used to determine the level of stress experienced by the individual during sensory training.

Information may be displayed to an individual using at least one display component provided within the visual training system. A display may comprise a region of one or more of the lenses able to display text, graphics, or other information. A display may be projected onto a lens, but alternatively/additionally a display may be generated on or within the lens itself. A display may be alphanumeric, pictographic, or in any other form that communicates information to an athlete. Alternatively or additionally, a display element may be incorporated into a portion of a frame retaining a lens or affixed to a frame and/or lens.

Information displayed may comprise training instructions or directions. For example, an individual may follow a pre-programmed training regimen by following the directions displayed. Such a training regimen may be designed to improve the visual skills of an individual, but may also be used to develop context specific physical skills in conjunction with the training of visual skills. For example, an individual may perform sport or rehabilitation related training activities while a visual training device adjusts the quantity and/or quality of visual information available to the individual. The display may indicate to the individual which training task to engage in next, the number of repetitions remaining, etc. The display may also be used to instruct the individual to increase or decrease the difficulty of training tasks performed, or to change the training task performed.

Information displayed may additionally or alternatively comprise feedback regarding some aspect of an individual's performance during training For example, the accuracy of a shot, the speed of a thrown ball, and the power of a swing are some types of information that may be displayed to an individual via a display during training. Information displayed may additionally or alternatively describe a physiological, kinematic, or other aspect of an individual's performance. For example, stability data may be displayed for a golfer practicing putting or other skills; heart rate and/or blood pressure information may be displayed to a biathlete practicing transitioning from skiing to shooting; eye tracking data may be displayed for a quarterback practicing reading defenses; any of a variety of other types of data or other information may be displayed to a training athlete. Information displayed may be raw data, such as numbers represented measured heart rate or blood pressure, but may also be processed in some way in order to be readily understood by a training individual. For example, balance or stability data may be indicated using a depiction of an individual's feet and a dot illustrating the individual's center of gravity. Physiological and/or performance data may be combined into a score or other indicator descriptive of an individual's training progress.

An individual's visual abilities may be trained by varying the quantity and/or quality of visual information available to the individual during training activities and/or by varying the difficulty of the training task(s) performed. The quantity and quality of visual information available to an athlete may be varied individually or in combination to improve the visual abilities of an individual and abilities, such as timing, that closely relate to visual abilities. The difficulty of training tasks may be varied in any way appropriate to the training task(s) in question, such as altering a training tempo, decreasing a target size, providing conflicting information (such as requiring an individual to respond in fashion contrary to a provided stimulus, such as to turn left in response to an oral instruction to turn right, and vice versa), or moving to a task more difficult for the individual training.

The quantity of visual information available to an individual may be varied using a lens switchable between a substantially transparent state and a substantially opaque state. All or part(s) of the lens may be switchable, and optionally individual elements or portions of a lens may be addressable to be switched between an opaque and a transparent state. The relative times for which a lens is in a transparent state versus an opaque state may be a measure of the quantity of visual information received by the individual. Additionally/alternatively, the relative amount of an individual's visual field occupied by a portion of a lens in a transparent state versus the amount of an individual's visual field occupied by a portion of a lens in an opaque state may be a measure of the quantity of visual information received by the individual. The quality of visual information available to an athlete may vary be varied by adjusting the power of the lens, by altering the microstructure of the lens to blur light passing through it, by only partially reducing the transparency of the lens, or through any other means that reduces the contrast, crispness, and/or clarity of visual information perceivable through the lens. Individual regions or portions of a lens may be individually addressable to vary the quality of the visual information transmitted by a lens. In some examples, a lens may be provided for each eye of an individual, with each lens being controlled distinct from the other lens. A recovery period may be provided by maintaining all or part of the lens(es) in a state providing a quantity and/or quality of visual information greater than that received during the training period for the duration of the recovery period. The increase in the quantity of visual information, the increase in quality of visual information, and/or the duration of the relative increase in the quantity/quality of visual information may comprise recovery period parameters that are adjusted based upon the performance metrics and/or physiological metrics recorded for the individual training In some examples, only one recovery period parameter, such as duration, is adjusted while other parameters, such as the quantity and/or quality of visual information provided the individual, are maximized during the recovery period.

One or more lens may be mounted to be worn over one or more eye of an individual for training A visor or shield design eyewear may provide a single lens, while a glasses frame may provide two lenses, one lens per eye. A lens may optionally provide visual correction for an individual, and may have optical properties to avoid distortion of an image to an athlete wearing the lens(es). A lens may optionally provide impact protection, protection from ultraviolet light, operate as sunglasses, filter some or all wavelengths of light to improve (or to impair, for training purposes) a wearer's perception of particular visual cues, etc.

An eyewear controller may control and/or power the one or more lens as appropriate to adjust the quality and/or quantity of visual information available to an individual. The eyewear controller may also control the display of information in a display component viewable by an individual during training if a display component is provided. The eyewear controller may be integral to the glasses, visor, or other structure retaining the lens(es) in position during training Similarly, a battery or other power source may be provided to power changes in quantity and/or quality of visual information available through lens(es). At least one communication interface may be provided as well, in order to permit the eyewear controller to interact with a control unit, sensors that measure performance or physiological parameters during training, and/or other devices.

By limiting the quantity of visual information available to an individual during training, an individual may develop his or her visual and related abilities to perform with that reduced level of information, thereby increasing the individual's performance when a full amount of visual information is available. Similarly, by reducing the quality of the visual information available to an individual, the individual's visual and related abilities may increase to compensate for the lower quality information available during training, thereby improving performance when the quality of visual information available has not been intentionally impaired. The time during which the quantity and/or quality of visual information is limited may be varied as well, determined for example to reduce quality and/or quantity of visual information available during different times of a training task, for example based upon sensor measurements, to more particularly develop an individual's abilities for specific aspects of a training task. Further, limiting visual information available to an individual, either in quality or in quantity, may assist the individual in better integrating other senses, such as auditory and/or proprioceptive senses, into her or his performance.

Sensors, eyewear with one or more lens controlling the quantity and/or quality of visual information available to the individual, and any control unit managing, recording, and/or adjusting training may communicate over various mediums and using any protocol. For example, a sensor may communicate wirelessly (via Bluetooth, an 802.11x protocol, or other standard) with a control unit. However, wired connections may be used in accordance with the present invention. A control unit may communicate wirelessly with an eyewear controller and/or sensors that measure performance and/or physiological parameters of an individual during training. A control unit and an eyewear controller may be discrete units, for example with the eyewear controller integral to the eyewear retaining one or more lens and the control unit operating on a special purpose or general purpose computing device. Alternatively, a control unit and an eyewear controller may comprise a single unit. While a division of functionality between an eyewear controller and a control unit are described in examples herein, in various implementations the functions performed by an eyewear controller(s) and a control unit(s) may be different than described herein, and may be distributed to additional or different devices.

More than one communication technique, medium, and/or protocol may be used. For example, a wired connection may permit a control unit to exchange information with an eyewear controller, while a wireless connection may permit an accelerometer to exchange information with the control unit.

The training conditions experienced by an individual and/or the sensory recovery period provided after training may be varied based upon the relative success (as described by performance metrics) and/or physiological response (as described by physiological metrics) of an individual during training Sensors may measure the performance of an individual and/or the physiological condition of an individual, and appropriate adjustment to the training program and/or the sensory recovery period provided after the training period may be made to facilitate acclimation to sensory training (or increasingly intense sensory training), to permit an individual to recover sufficiently to effectively for an upcoming training period, and to challenge but not discourage the individual training.

The training program may be adjusted using a display component to provide instructions to an athlete to alter the training program. The alteration of the training program may be to increase the difficulty of training to maximize positive training effects, to decrease the difficulty of training to avoid discouragement, and/or to change the nature of training to address a different ability or skill. For example, an individual may be instructed to move to a different task, to use a different target for throwing/shooting/kicking/putting/driving/etc., or to otherwise alter the training regimen.

The visual aspects of the training may also be adjusted based upon performance and/or physiological metrics. For example, the quantity of visual information may be increased or decreased and/or the quality of visual information may be increased or decreased. For example, if an individual has mastered a training exercise with first level of visual information that provides a first quantity and/or quality of visual information, the control unit may adjust the training to a second level of visual information providing a decreased second quantity and/or quality of visual information. On the other hand, if an individual is struggling with a given level of visual information, the quantity and/or quality of visual information may be increased to a third quantity and/or quality. In some examples, the quality of visual information may be decreased while the quantity of visual information may be increased, or vice versa, in order to train different aspects of an individual's visual or related physical abilities. The quantity of visual information may be adjusted by decreasing the amount of time during which a lens is in an entirely or partially transparent state, by decreasing the area of a lens that is in a transparent state, and/or (if a lens is provided for each of an individual's eyes) opening only a single lens into a transparent state at a time.

Recovery period parameters may also be adjusted based upon performance and/or physiological metrics. For example, if performance metrics indicate a predefined number of failures, and/or if physiological metrics indicate a level of stress beyond a predefined threshold, a recovery period may commence sooner than otherwise anticipated by a training program. Other recovery parameters that may be adjusted based upon the performance and/or physiological metrics of an individual training include, but are not limited to, the duration of the recovery period, the quantity of visual information provided to the individual during the recovery period, and/or the quality of visual information provided to the individual during the recovery period. By way of further example, if performance metrics indicate a predefined number of successes, and/or if physiological metrics indicate a level of stress below a predefined threshold, the beginning of a recover period may be delayed, the duration of a recovery period may be reduced, the quality of the visual information provided during the recovery period may be lowered, and/or the quantity of visual information provided during the recovery period may be reduced. One or all recovery period parameters may be adjusted in response to performance and/or physiological metrics. In some examples, physiological metrics may be measured during a sensory recovery period and those physiological metrics may be used to further adjust the recovery period parameters. For example, physiological metrics indicating ongoing duress may lead to the duration of a recovery period being extended while physiological metrics indicating reduced stress may lead to a shortened recovery period. By way of yet further example, in some instances a sensory recovery period may coincide with an ongoing physical training period, in which case performance metrics obtained during the sensory recovery period may be used to adjust recovery period parameters.

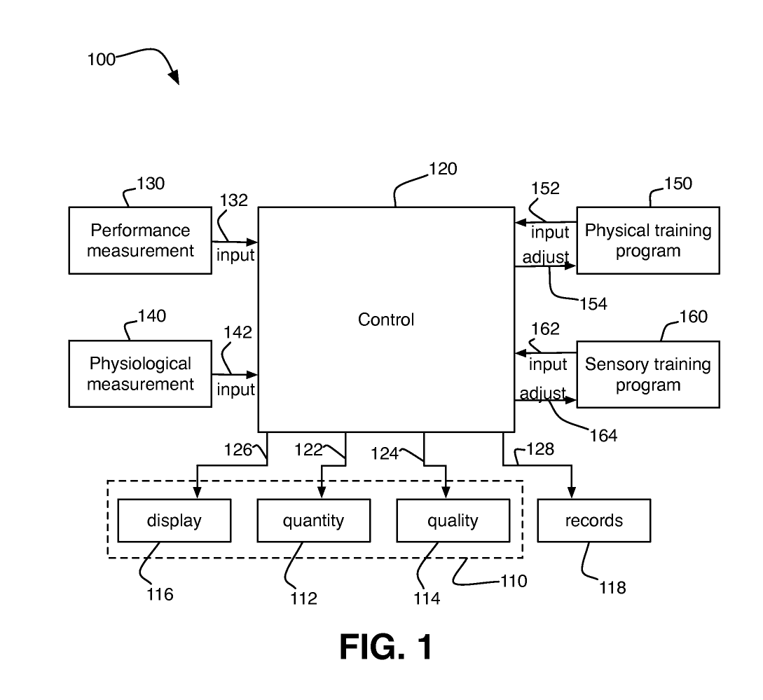

FIG. 1 illustrates an example of a system 100 in accordance with the present invention. An eyewear component 110 may control the quantity 112 of visual information provided to an individual and/or the quality 114 of visual information provided to an individual. Eyewear component 110 may also have a display 116 to provide visual information to an individual. Display 116 may provide information to an individual describing the performance of the individual during training, the physiological measurements of the individual during training, information describing the quantity or quality of sensory information provided to the individual during training, information describing the difficulty of the physical training, or other information (such as time remaining in training, receptions of a drill remaining, a summary of physiological or performance metrics, a description of the quantity/quality of visual information being provided by the eyewear to the individual, etc.). Display 116 may additionally/alternatively provide directions, instructions, or other information to an individual. Performance measurements 130 and physiological measurements 140 may be made by one or more sensors.

A control unit 120 may receive performance measurement 130 inputs 132 and/or physiological measurement 140 inputs 142. A control unit 120 may also control via signal 122 the quantity 112 of visual information available to an individual, may control via signal 124 the quality 114 of visual information available to an individual, and may control via signal 126 the information displayed 116 to an individual. A control unit 120 may control the operation of eyewear components 110 directly or via an eyewear controller.

A control unit 120 may receive an input 152 of a physical training program 150 to be performed by an individual. A physical training program may define or describe, for example, the drills, tasks, exercises, or other training actions to be undertaken by an individual. Based upon criteria, such as performance measurements 130 and/or physiological measurements 140, a control unit 120 may adjust 154 a physical training program 150.

A control unit 120 may additionally/alternatively receive an input 162 of a sensory training program 160. A sensory training program may define or describe, for example, the quantity 112 and/or quality 114 of visual information an individual will receive through an eyewear component 110 during training A sensory training program 160 may be coordinated with a physical training program 150, but such coordination is not necessary. Based upon criteria, such as performance measurements 130 and/or physiological measurements 140, a control unit 120 may adjust 164 a sensory training program 160.

One or more record 118 may be made of the physical and/or sensory training of an individual. A record 118 may describe one or more of the individual engaging in a training program, the time or date of the training, the physical training program 150 executed, the sensory training program 160 executed, performance measurements 130 made during training, and/or physiological measurements 140 made. A record 118 may be maintained in an appropriate computer readable form in any type of memory or storage device. A record 118 may be maintained within a control unit 120, within an eyewear component, or at another location. One or more records 118 may be periodically copied or moved to a database or other storage system.

While control unit 120 is shown in the example of FIG. 1 as separate from eyewear component 110, control unit may be integral with eyewear component 110. Further, control unit 110 may comprise one or more computing devices having a processor executing computer readable instructions from one or more non-transitory media to operate as described herein.

Adjustments of a training program may relate to the physical training tasks performed and/or the quantity of visual information 112 and/or the quality of visual information 114 available to an individual. For example, if performance measurements 130 and/or physiological measurements 140 indicate that an individual has been successful at a task of a particular level of difficulty, the difficulty of a subsequent training task may be increased in one or more fashion. On the other hand, if performance metrics 130 and/or physiological metrics 140 indicate that an individual has not been successful at a task of a particular level of difficulty, the difficulty of a subsequent training task may be decreased.

For example, a sensor may determine that a basketball player shooting a ball from a particular location on the floor with a particular quantity and quality of visual information has reached a threshold level of success, such as, for instance, hitting five consecutive shots. In such an example, the parameters of a planned sensory recovery period may be adjusted, the basketball player may be instructed to move further from the basket, the quality of the visual information provided to the basketball player may be decreased, and/or the quantity of visual information provided to the basketball player may be decreased. Conversely, a lack of success (such as a basketball player missing a given number of shots) may result in changes to the parameters of a sensory recovery period, the training becoming easier by instructing the individual to move closer to the basket, increasing the quality of visual information available to the individual, and/or increasing the quantity of visual information available to the individual. Of course, the present invention is not limited to any particular sport or training task, but may be applied for any type of sport, rehabilitation, and/or other training, and may involve any type of physical training task associated with a sport or type of rehabilitation.

A sensory training program 160 may provide a sensory recovery period during which the sensory load placed upon the individual by the eyewear 110 is reduced or eliminated. The parameters of a sensory recovery period may be modified based upon performance metrics obtained from performance measurements 130 and/or physiological metrics obtained from physiological measurements 140. For example, if sensors indicate that an individual is struggling to maintain his or her balance, the sensory challenge may be eliminated to provide the individual with a sensory recovery period. By way of further example, if physiological metrics indicate that the individual is experiencing stress above a predefined threshold, a sensory recovery period may be commenced or extended. Conversely, if physiological measurements indicate a level of stress below a predefined threshold, a sensory recovery period may be delayed or shortened. Likewise, performance metrics may be used (alone or in conjunction with physiological metrics) to adjust one or more recovery parameter. One or more of a plurality of recovery parameters may be adjusted based upon performance metrics and/or physiological metrics.

In some instances an assessment may be obtained for an individual to permit the individual to evaluate his or her improvement relative to a prior assessment or in comparison to other individuals. In some examples, such an assessment may be used to establish a baseline for subsequent training by that individual and/or to set thresholds for use in adjusting recovery period parameters. Adjustments to training difficulty, whether to increase or to decrease the difficulty of training, may be made dynamically during training but may additionally/alternatively be made between training sessions and/or during breaks of a training session. In some examples, certain types of adjustments to training difficulty may be made dynamically during training, such as changes in the quality and/or quantity of visual information available to an individual, while other types of adjustments to training difficulty, such as the parameters of a training task, may be adjusted during breaks in training

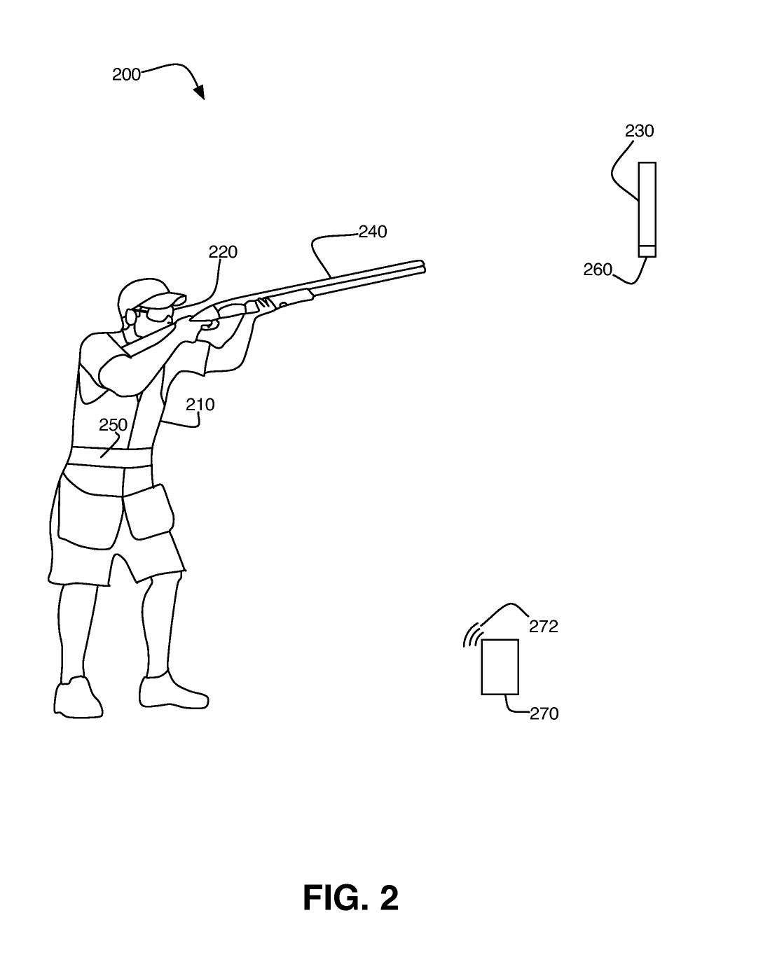

FIG. 2 illustrates an example individual 210 training using a gun 240 to shoot a target 230 using a system 200 in accordance with the present invention. An eyewear component comprising glasses 220 control the quantity and/or quality of visual information available to individual 210. A sensor 260 associated with target 230 may be used to provide a performance measurement by measuring the accuracy of a shot from gun 240 in striking target 230. Sensor 260 may be physically affixed to target 230, as illustrated in the example of FIG. 2, but may also be physically integrated into a target. For example, a single-use sensor may be incorporated into a “clay pigeon” to detect the disintegration of the pigeon, thereby indicating a successful shot. A sensor such as sensor 260 may be single use or multiuse and may measure performance outcomes in any fashion. For example, a sensor may detect a vibration, electrical signal, or any other measurement indicative target 230 being hit. Additionally/alternatively, sensor 260 may be physically disconnected from target 230 and may utilize sound detection, image detection, or other means to determine whether target 230 has been successfully hit. In other contexts, such as other sports or rehabilitation, other types of sensors may be used to capture performance metrics. A sensor 250 associated with individual 210 may provide one or more physiological measurement by measuring the heart rate, blood pressure, movement, stability, or other data describing biological or medical condition of individual 210. A control unit 270 (illustrated as a discrete component for illustrative purposes in the example of FIG. 2) may communicate wirelessly 272 with glasses 220, performance sensor 260, and/or physiological sensor 250. Based upon performance measurements and/or physiological measurements, control unit 270 may adjust the quantity and/or quality of visual information received by individual 210 through glasses 220. Optionally, control unit 270 may use a display component within glasses 220 to display information or instructions to individual 210. Instructions provided to individual 210 may increase or decrease the difficulty of physical training tasks in response to performance measurements and/or physiological measurements.

The example of the present invention illustrated in FIG. 2 is not limited to any particular sport or type of training, and may be used for skills, such as basic balance and coordination, that are needed for rehabilitation services. In some examples, the training task(s) performed may simulate the physical acts to be performed by the individual training For example, instead of the shooting example depicted in FIG. 2, a laser system mounted on a gun 240 may simulate shooting, with an appropriate sensor detecting the laser in relation to the target. Similarly, American football players may perform practice drills, such as receivers running routes and attempting to catch passes, rather than engaging in a scrimmage. Likewise, when systems and methods in accordance with the present invention are used in the context of rehabilitation, the training tasks performed may comprise movements or other acts that comprise the building blocks of the activities the individual training wishes to be able to perform. The performance and/or physiological data measured may vary from the examples described herein. In some examples, systems and methods in accordance with the present invention may implement only some types of sensors, such as only performance sensors or only physiological sensors or only certain types of performance or physiological sensors. Similarly, some implementations of the present invention may adjust only the quantity or only the quality of visual information, or may only restrict one of the quality or the quantity of visual information provided.

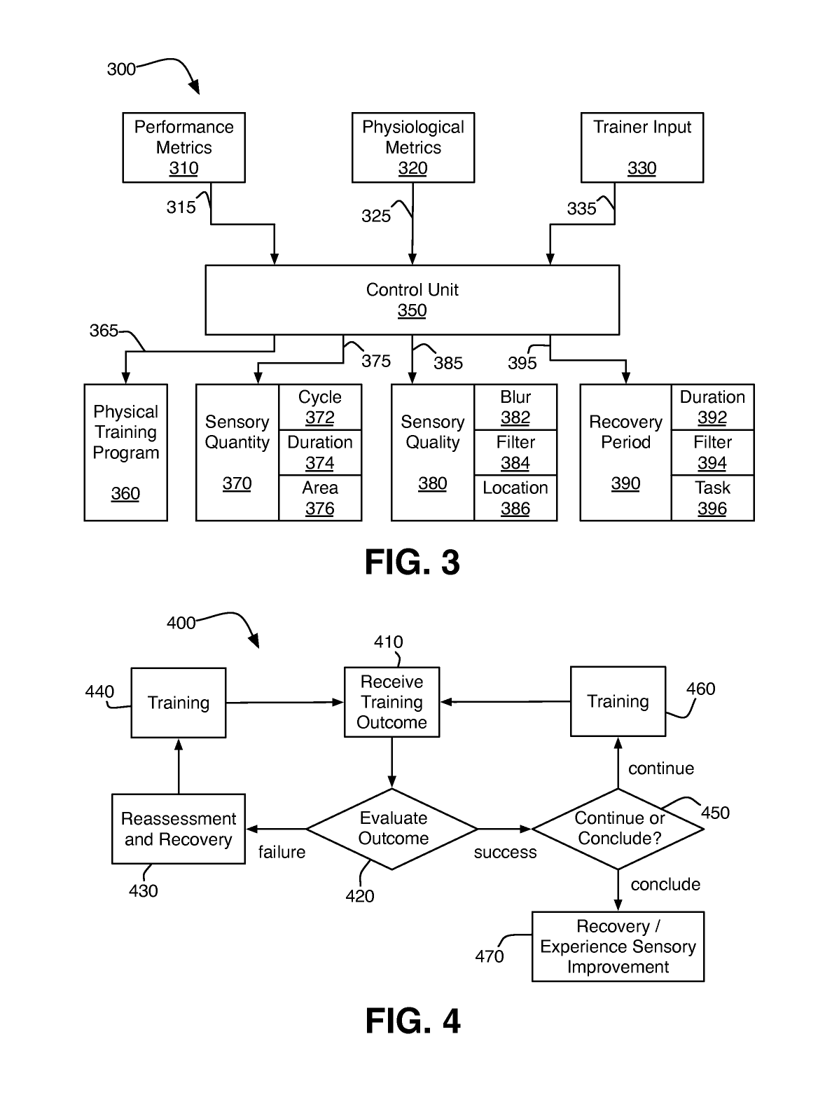

Referring now to FIG. 3, a further example of a system 300 in accordance with the present invention is illustrated. Performance metrics 310 may be based upon sensor measurements and communicated to a control unit 350 via a connection 315. Performance metrics 310 may comprise any type of measurement of the relative success of a training task, such as hitting a shot, making an accurate throw, moving along the desired path, or a coach or other trainer affirming that a task was successfully completed (for example, using a device such as a mobile phone, computer, remote control, or other device to indicate the successful or unsuccessful completion of a training task). Performance metrics may be binary, indicating either “successful” or “not successful” in some way, but may also be relative. For example, a training task may be repeated for a certain number of repetitions, such as five, with success indicated by the number of successful repetitions. Additionally/alternatively, a performance metric may comprise a metric such as proximity to a target, either in an absolute sense (for example, six centimeters from the target) or in a relative sense (for example, the second ring of the bulls eye). Further, a training metric may comprise a time of completion, a force generated, a degree of rotation of the individual's body or a piece of equipment, a distance covered, or any other description of the performance of an individual engaged in a training task. More than one metric may be collected as part of performance metrics 310.

Still referring to FIG. 3, physiological metrics 320 may be collected and communicated to control unit 350 via connection 325. Some examples of physiological metrics 320 are described herein, but any measurement describing the physiological response of an individual to training may be used in accordance with the present invention. Further, more than one physiological metric 320 may be collected in accordance with the present invention.

Trainer input 330 may optionally be communicated to control unit 350 via connection 335. Trainer input 330 may comprise evaluations by a trained individual (such as a coach, doctor, or physical therapist) of the performance of an individual training in accordance with the present invention, but need not comprise training metrics 310. In some examples, trainer input 330 may comprise an input from the individual training that assesses how the individual subjectively feels about the training process. Trainer input 330 may comprise inputs for application in subsequent training sessions, for example. In some examples, a trainer input 330 may immediately interrupt a training session, for example to immediately remedy a training error, such as may occur if the individual training is performing a training task incorrectly, or to protect the health, safety, or wellbeing of the individual training.

One or more of the performance metrics 310, physiological metrics 320, and trainer input 330 may be omitted in accordance with the present invention. For example, if a particular implementation of the present invention is more concerned with physiological evaluation and/or training, both the performance metrics 310 and/or trainer input 330 may be omitted. On the other hand, if a particular implementation of the present invention is primarily focused on improving training outcomes through improved sensory skills, physiological metrics 320 and/or trainer input 330 may be omitted. In yet other examples, only trainer inputs 330 may be used.

The control unit 350 may control various aspects of physical and/or sensory training based upon prior programming and/or received data such as the performance metrics 310, physiological metrics 320, and/or trainer input 330 received. The physical training program 360, which may be communicated to an individual using a display component, an auditory signal, or through other communication means, may be varied to best serve the training objectives in light of the received data. Similarly, the sensory quantity 370 and/or sensory quality 380 available to an individual may be adjusted in light of the received data to provide optimized training. Additionally/alternatively, the recovery period 390 may be adjusted based upon the received data.

Sensory quantity 370 may be adjusted in various ways. For example, the cycle 372 in which the amount of sensory information available to an individual is restricted may be adjusted. The cycle 372 may comprise a frequency, for example the frequency at which all or part of the lens(es) obscure an individual's vision. Sensory quantity 370 may also be adjusted by changing the duration 374 for which sensory information is, or is not, provided to an individual. For example, within a given cycle 372 lens(es) may transmit visual information to an individual for only a certain period of time or a percentage of the cycle. A longer duration 374 without visual information may be more stressful to an individual than a shorter duration 374 without visual information. Further, the area 376 in which lens(es) limit visual information may be varied. For example, lens(es) may limit an individual's entire field of view, but alternatively may limit only a fractional portion or percentage of an individual's field of view. While the portion of a field of view limited may alter the stress applied to an individual in training, particularly if the portion is contiguous rather than distributed over the entire field of view in a checkerboard fashion, generally the greater the area without sensory information provided the greater the sensory stress placed upon an individual. Another example of limiting the quantity of visual information provided to an individual is to limit visual information available to a single eye at a time.

Sensory quality 380 may also be adjusted in various ways. For example, a visual signal may be degraded using a blur 382 that de-focuses light passing through the lens(es). A blur 382 may be controlled by adjusting the curvature, power, and/or distribution of particles within lens(es). By way of further example, a filter 384 that selectively removes light passing through lens(es) based upon the wavelength of that light may make the visual information provided to an individual either higher quality or lower quality, depending upon whether the wavelengths removed by filtering are extraneous noise or critical information to the task being performed.

A recovery period 390 may be provided during which no or little reduction in either the quantity 370 and/or quality 380 of visual information is performed. A recovery period 390 may be useful to facilitate desensitization to the physical and/or sensory stress associated with training, or even to avoid negative physiological responses, such as nausea and dizziness, that may occur in individuals engaging in perceptual stress training Based upon the received information, the control unit 350 may adjust parameters of a recovery period. For example, the duration 392 of a recovery period may be adjusted, the quantity 370 of sensory information provided during the recovery period may be adjusted, the quality 380 of sensory information may be adjusted, and/or the timing of a recovery period may be adjusted relative to other training activities. Further, a filter 394 may be applied for a recovery period 390 based upon the received information, as some filters may be particularly soothing or beneficial to an individual in some circumstances. Additionally/alternatively, the task(s) 396 performed during a recovery period 390 may vary based upon the received information.

Variations of a recovery period 390 in accordance with the present invention may differ based upon the purpose of a particular recovery period 390. For example, if a recovery period 390 is intended to permit an individual to recover from negative physiological metrics 320, the duration 392 may be extended until sufficiently improved physiological metrics 320 and/or a trainer input 330 indicating a readiness to continue is received by control unit 350. If a recovery period 390 is intended to correct a training error indicated from a training metric 310 and/or a trainer input 330, may be relatively short, or may last until a training input 330 indicating a readiness to resume training is received by control unit 350. In some examples, a trainer input 330 may comprise an input from the individual training or another person supervising the training to indicate that he or she is ready to resume training and/or that the individual is not ready to resume training By way of further example, if a recovery period 390 is intended to enhance the confidence of an individual training and/or to provide an immediate improvement to the performance of the individual, an appropriate task 396 may be performed in order for the individual to experience the positive effects of the sensory training. A recovery period 390 may be abrupt or gradual. For example, an individual may gradually receive increasing quantities of visual information during the beginning or the entirety of a recovery period 390. For example, an individual working to improve balance skills may develop balance abilities through training with peripheral visual information reduced or entirely eliminated, and during a recovery period 390 some or all of the peripheral visual information may be restored to the individual.

Referring now to FIG. 4, an exemplary method 400 in accordance with the present invention is illustrated. Method 400 may receive a training outcome in step 410. A training outcome may comprise, for example, one or more performance metric, one or more physiological metric, and/or one or more trainer input. The training outcome may be evaluated in step 420. Step 420 may involve comparing the training outcome to predefined parameters or goals, in comparison to an individual's prior performance, based on a binary determination of success, based upon comparing physiological metrics to predefined thresholds, or any other determination. If the outcome of evaluation 420 is that the training task was a failure, method 400 may proceed to step 430 of reassessment and recovery in order to allow the individual to improve upon his or her performance. Method 400 may then proceed from step 430 to a training step 440. The training of step 440 may be at a different degree of difficulty, such as lower difficulty, than training previously performed unsuccessfully. If the result of evaluation step 420 is that the training task was a success, method 400 may proceed to step 450 to determine whether to continue or conclude that component of training Step 450 may determine to conclude a component of training if, for example, an individual has successfully completed a training task based upon a predetermined success threshold. A success threshold may be related to attaining a particular performance metric, such as successfully completing five consecutive tasks, and/or an evaluation of a physiological metric against a threshold. If the determination of step 450 is to continue with training, method 400 may proceed to an additional training step 460. The training of step 460 may be more or less difficult than previous training, for example by increasing difficulty after training is performed successfully and/or decreasing difficulty after training is performed unsuccessfully. After a training step, such as training step 460 and/or training step 440, method 400 may return to step 410 to receive training outcomes. If step 450 determines to conclude the component of training, method 400 may proceed to step 440 of providing a recovery period during which the individual may experience a sensory improvement from the training. In some examples, measurements of the individual's performance may be made during a recovery period to provide an indication of the efficacy of the training Method 400 may thereafter conclude or resume with a training step, potentially training addressing a different skill.

Methods in accordance with the present invention, such as exemplary method 400, may be applied to train sensory abilities in a wide variety of physical contexts. A context may comprise a particular sport or athletic endeavor, rehabilitation of a particular kind, or any other effort to improve an individual's sensory skills with application to an environment, behavior, or task.

By way of example, methods in accordance with the present invention may be used to train the sensory abilities of a golfer within the context of a club swing. In such an example, performance sensors could monitor club trajectory, the ball and/or club head position or point of contact, ball trajectory information (such as launch angle, trajectory, rotation, etc.), and/or proximity to the target for the shot. For golf-related training, physiological metrics may comprise data such as stability data (such as a center of pressure reading from sensor(s) beneath the golfer or in the golfer's shoes) and/or a ground reaction force vector measured during the golfer's swing. A recovery period may be provided to a golfer based upon the performance and/or physiological metrics to enable the golfer to experience the benefit from his or her work (ie, the attainment of “effortless power”) if the metrics exceed predefined thresholds or may be provided to lessen frustration or discouragement if the metrics fall below a predefined threshold.

By way of further example, methods in accordance with the present invention may be used in conjunction with shooting sports. Performance metrics may be derived from sensors in targets (such as clay pigeons) that record whether a shot has been hit or missed, whether the correct target was selected, etc. Another example of a potential performance metric is the relative stillness of the barrel of the gun when a shot is fired. Physiological data may be stability data, eye movement data, heart rate, breathing rate, etc. Recovery period parameters may be adjusted based upon performance metrics (such as whether five consecutive targets have been hit) and/or physiological metrics (such as whether the shooter is experiencing stress above a defined threshold).

A further example of methods in accordance with the present invention are those that may be used for rehabilitation after a traumatic brain injury or concussion. Performance metrics may involve a response to stimuli, such as avoiding obstacles or correctly responding to questions/instruction verbally or through actions. Physiological metrics may comprise stability data or other indications of vertigo. Based upon the performance metrics and/or the physiological metrics, sensory recovery period parameters may be adjusted to avoid aggravating symptoms while maintaining an effectively challenging program.

Methods in accordance with the present invention may further be used in conjunction with rehabilitation of the lower extremities of an individual. Performance metrics in such training may comprise stability data as an individual performs various exercises (standing with assistance, standing without assistance, squatting, walking, landing from a drop jump, running, jumping, changing direction, etc. Physiological parameters may comprise heart rate, breathing rate, the ability to stabilize the head (referred to as shock attenuation), etc. Recovery period parameters could be adjusted to initiate a recovery period when one or more of the performance parameters and physiological parameters falls outside of predefined thresholds that indicate fatigue or failure of the individual. Additionally/alternatively, a previously planned recovery period may be shortened or lengthened in duration based upon whether the performance metrics indicate success or failure of the individual and/or whether the physiological metrics indicate the individual is experiencing a small or a large amount of duress.

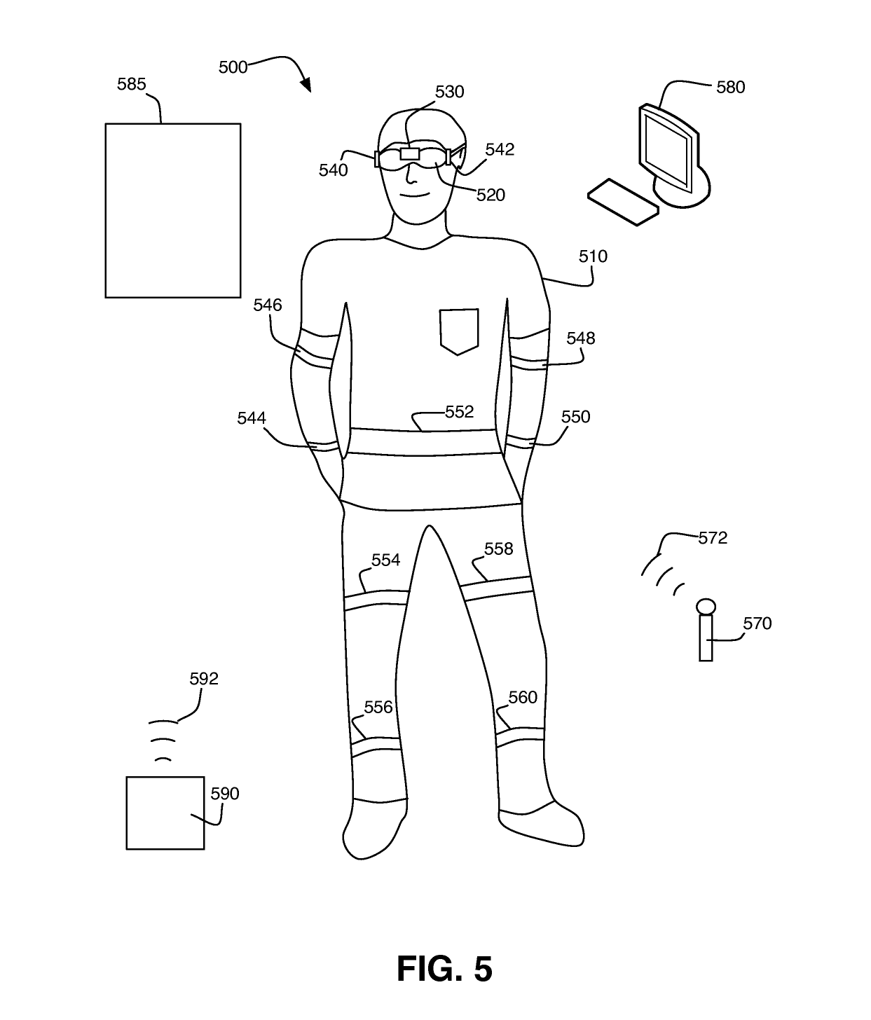

FIG. 5 illustrates a system 500 in accordance with the present invention for administering a program to train the physical, neurological, sensory, and/or other abilities of an individual 510. Individual 510 is wearing eyewear 520 with an integrated control unit 530. A first sensor 540 and a second sensor 542 are integrated into eyewear 520.

Additional sensors are integrated into wearable technology worn by individual 510. In the example illustrated in system 500 of FIG. 5, a first wrist sensor 544, a first elbow sensor 546, a second elbow sensor 548, a second wrist sensor 550, a waist or torso sensor 552, a first knee sensor 554, a second knee sensor 558, a first ankle sensor 556, and a second ankle sensor 560 are illustrated. However, more, fewer, and/or different sensors than those depicted in FIG. 5 may be used in accordance with the present invention. The plurality of sensors illustrated in FIG. 5 may be in communication with control unit 530 via any wired or wireless communication protocol. The sensors may all be of the same type, but may be of different types. For example, eye tracking sensors, inertial sensors, pressure sensors, and perspiration sensors may all be used, as may any other combination of wearable sensors.

Still referring to FIG. 5, at least one external measurement system 570 may optionally be provided to record further data regarding the performance of individual 510. Measurement system 570 may use signals 572 to make measurements describing the performance of individual 510 and portions of the anatomy of individual 510 during a testing/training program. Signals 572 may be, for example, infrared, visible light, radio frequencies, etc. Further, signals 572 may comprise light or other wavelengths of electromagnetic radiation reflected off of markers worn by individual 510. Further, signals 572 may comprise sound waves, ultrasonic waves, subsonic waves, were any other type of signal.

Further, system 500 may provide external stimuli 592 created by a generator 590. One example of a generator 590 is a metronome that provides a rhythmic stimuli 592 for individual 510 to comply with in performing a physical activity, but any other type of stimuli 592, predictable or unpredictable, may be used in conjunction with the present invention to provide a varying difficulty of a testing/training program. A stimuli 592 may comprise a distraction to individual 510, but may additionally provide a second input directing individual 510 in the actions of a testing/training program.

Still referring to FIG. 5, one or more external computing device 580 may be used in real-time or non-real-time coordination with a control unit 530, measurement system 570, and/or external stimuli 592 generator 590. In some examples, additional computer 580 may be used to program processing unit 530 and/or to store performance records made by sensors and communicated to processing unit 530 during a testing/training program.

One or more heads-up display may be integrated into eyewear 520 in order to provide program instructions to individual 510. Additionally/alternatively, an external display 585 may be provided to provide program instructions to individual 510 undergoing testing/training in accordance with the present invention.

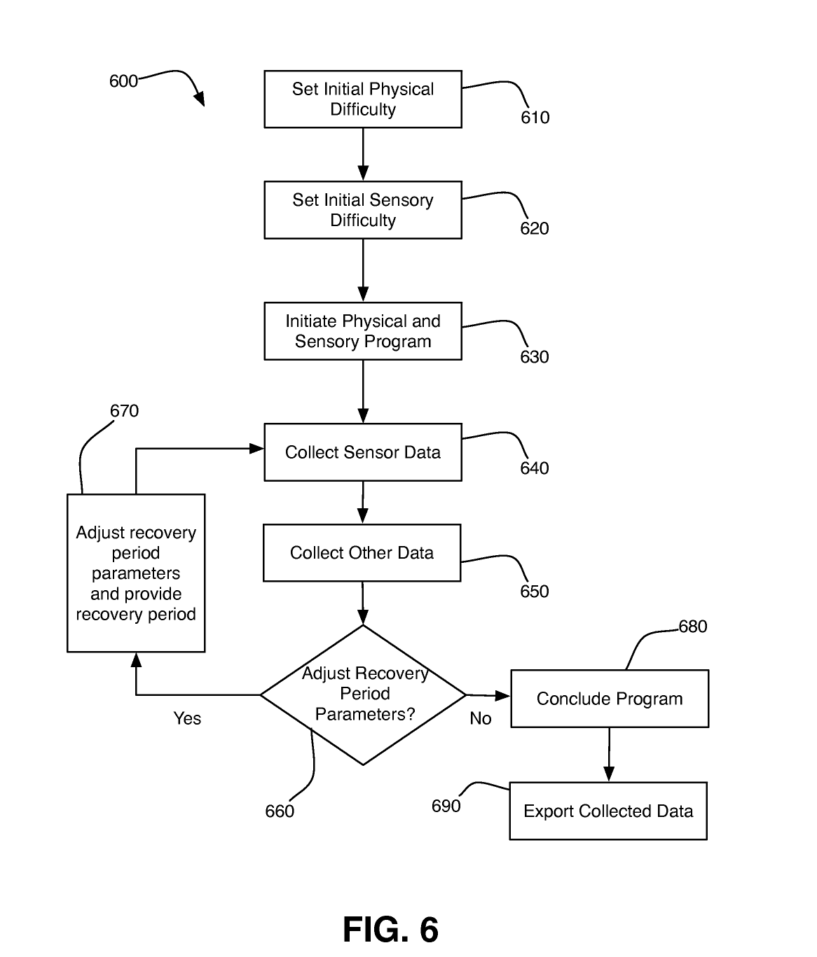

Referring now to FIG. 6, a method 600 in accordance with the present invention is illustrated. Method 600 may begin at step 610 of setting the physical difficulty of a training program. Method 600 may also comprise step 620 of setting the initial sensory difficulty of a testing/training program. The sensory difficulty set in step 620 may include anticipated recovery period parameters to provide an opportunity for an individual training to experience a reduced sensory load in order to experience the benefits of training and/or to acclimate to the training, avoid discouragement, etc. The physical difficulty setting step 610 may relate to the physical challenge of the tasks to be performed at the direction of symbols provided on one or more heads-up display, while the sensory difficulty set in step 620 may relate to the quantity and/or quality of visual information provided by the lens(es) of the eyewear worn by the individual. Based upon the settings made in step 610 and in step 620, the physical and sensory program may be initiated in step 630. During the performance of the training program initiated in step 630, sensor data may be collected from wearable sensors describing the performance of the activities during activities the performance of the testing/training program in step 640. In step 650 other data collected by external measurement systems may be collected. The data collected in steps 640 and 650 may comprise performance and/or physiological metrics. Based upon the collected data, step 660 may determine whether to adjust the recovery period parameters. If the conclusion of step 660 is that one or more recovery period parameter should be adjusted (for example, because the training has been easy for the individual, thereby requiring little or no recovery period, or because the training has been excessively hard for the individual, thereby requiring lessening of the sensory load), method 600 may proceed to step 670 to adjust the recovery period parameters and provide the resulting recovery period. After step 670, method 600 may then return at the adjusted difficulty level(s) to step 640 to collect sensor data and step 650 to collect other external measurement data with the individual performing the program with increased or decreased physical and/or sensory difficulty. If the outcome of step 660 is that no adjustment of difficulty is required, method 600 may ultimately proceed to step 680 of concluding the testing/training program. Optionally, method 600 may continue to export collected data in step 990, for example through a communication interface to an external computing device.

Method 600 may be performed iteratively for a number of times, either contemporaneously or over the course of hours, days, weeks, months, or even years to provide repeated measurements and/or training of an individual's athletic, sensory, neurological, cognitive, and other functions.

While systems and methods in accordance with the present invention have been described in examples herein, the present invention is not limited to the above examples. The present invention may be used in contexts beyond those described herein, and the performance and/or physiological metrics assessed in adjusting sensory recovery period parameters may vary as well. Different performance and/or physiological metrics may be relevant for different individuals in different contexts. Likewise, the use of performance metrics and/or physiological metrics to adjust sensory recovery period parameters may vary. Performance and/or physiological metrics may be compared to metric thresholds determined prior to the training beginning and/or to metric thresholds determined based at least in part on metrics collected during a training session. In some instances, collected metrics may be assessed against a predefined threshold based upon a prior assessment of the individual training, perhaps even earlier in a training session, while in some instances collected metrics may be compared to one or more threshold determined in whole or in part without prior metrics collected from the individual. Further, more than one threshold may be applied, such that at a metric at a first level results in a first modification of sensory recovery period parameters, a metric at a second level results in a second modification of sensory recovery period parameters, a metric at a third level results in a third medication of sensory recovery parameters, and so on.

1. A system for training sensory and physical skills, the system comprising:
eyewear that alters at least one of the quantity and the quality of visual information available to an individual performing a first training task while wearing the eyewear;
at least one performance sensor that measures at least one performance metric while the individual performs the first training task;
at least one physiological sensor that measures at least one physiological metric of the individual while the individual performs the first training task; and
at least one control unit that receives the at least one performance metric and the at least one physiological metric and that causes the eyewear to cease altering both the quality and the quantity of visual information available to the individual for a recovery period, the duration of the recovery period determined by the at least one control unit by comparing the at least one performance metric and the at least one physiological metrics to standards defined prior to the individual performing the first training task.

2. The system for training sensory and physical skills of claim 1, wherein the at least one control unit causes the eyewear to provide a recovery period of a first duration if the at least one performance metric indicates a successful completion of the first training task and causes the eyewear to provide a recovery period of a second duration if the at least one performance metric indicates an unsuccessful completion of the first training task, the second duration being longer than the first duration.

3. The system for training sensory and physical skills of claim 1, wherein the at least one control unit causes the eyewear to provide a recovery period of a first duration if the at least one physiological metric indicates a physiological stress level below a defined threshold while the individual performed the first training task and causes the eyewear to provide a recovery period of a second duration if the at least one physiological metric indicates a physiological stress level above the defined threshold while the individual performed the first training task, the second duration being longer than the first duration.

4. The system for training sensory and physical skills of claim 1, wherein:
the at least one control unit causes the eyewear to provide a recovery period of a first duration if the at least one performance metric indicates a successful completion of the first training task and the at least one physiological metric indicates a physiological stress level below a defined threshold while the individual performed the first training task;
the at least one control unit causes the eyewear to provide a recovery period of a second duration if the at least one performance metric indicates an unsuccessful completion of the first training task and if the at least one physiological metric indicates a physiological stress level above the defined threshold while the individual performed the first training task, the second duration being longer than the first duration;
the at least one control unit causes the eyewear to provide a recovery period of a third duration if the at least one performance metric indicates an unsuccessful completion of the first training task and if the at least one physiological metric indicates a physiological stress level below the defined threshold while the individual performed the first training task, the third duration being longer than the first duration and shorter than the second duration;
the at least one control unit causes the eyewear to provide a recovery period of a fourth duration if the at least one performance metric indicates an successful completion of the first training task and if the at least one physiological metric indicates a physiological stress level above the defined threshold while the individual performed the first training task, the fourth duration being longer than the first duration and shorter than the second duration.

5. A method for training the visual abilities of an individual in conjunction with training the physical abilities of the individual, the method comprising:
providing the individual with eyewear that, as directed by a control unit, places a sensory load upon the individual by restricting at least one of the quantity and the quality of visual information available to the individual in accordance with a sensory training program while the individual wears the eyewear, wherein the training program provides at least one sensory recovery period during which the sensory load placed upon the individual by the eyewear is reduced, the sensory recovery period defined by sensory recovery period parameters;
instructing the individual to perform at least one physical training task while the eyewear increases the sensory load placed upon the individual; measuring at least one performance metric descriptive of the outcome of the at least one training task performed by the individual using at least one performance sensor;
measuring at least one physiological metric descriptive of the physiological state of the individual;
receiving the at least one performance metric and the at least one physiological metric at the control unit;
adjusting the sensory recovery period parameters based upon a comparison of the at least one performance metric and the at least one physiological metric to at least one predefined threshold; and
reducing the sensory load placed upon the individual by providing a sensory recovery period as defined by the adjusted sensory recovery period parameters.

6. The method of claim 5, wherein measuring at least one physiological metric occurs while the individual performs a training task.

7. The method of claim 5, wherein measuring the at least one physiological metric occurs during a sensory recovery period.

8. The method of claim 5, wherein the sensory recovery period sensory parameters specify a duration during which the eyewear places no sensory load on the individual.

9. The method of claim 8, wherein receiving performance metrics descriptive of multiple failures at the training tasks results in the duration of the sensory recovery period being extended.

10. The method of claim 8, wherein receiving physiological metrics descriptive of stress in excess of a predefined threshold results in the duration of the sensory recovery period being extended.

11. The method of claim 5, wherein the sensory recovery period parameters specify an increase in the quantity of visual information provided to the individual by the eyewear during a sensory recover period in order to reduce the sensory load on the individual.

12. The method of claim 11, wherein receiving performance metrics descriptive of multiple failures at the training tasks results in the quantity of visual information provided by the eyewear during the sensory recovery period being increased.

13. The method of claim 11, wherein receiving physiological metrics descriptive of stress in excess of a predefined threshold results in the quantity of visual information provided by the eyewear during the sensory recovery period being increased.

14. The method of claim 5, wherein the sensory recovery period parameters specify an increase in the quality of visual information provided to the individual by the eyewear during a sensory recover period in order to reduce the sensory load on the individual.

15. The method of claim 14, wherein receiving performance metrics descriptive of multiple failures at the training tasks results in the quality of visual information provided by the eyewear during the sensory recovery period being increased.

16. The method of claim 14, wherein receiving physiological metrics descriptive of stress in excess of a predefined threshold results in the quality of visual information provided by the eyewear during the sensory recovery period being increased.

17. A system for training sensory of an individual while the individual performs physical training tasks within a physical context, the system comprising:
eyewear that alters the quantity of visual information available to the individual performing training tasks while wearing the eyewear such that the individual receives a first quantity of visual information while performing the training tasks, the first quantity of visual information being reduced from that available to the individual without the eyewear;
at least one performance sensor that measures at least one performance metric descriptive of the success of the training tasks performed by the individual;
at least one physiological sensor that measures at least one physiological metric of the individual while the individual performs the training tasks; and
at least one control unit that receives the at least one performance metric and the at least one physiological metric, the control unit causing the eyewear to provide the individual a sensory recovery period during which the individual receives a second quantity of visual information that is greater than the first quantity of visual information, the sensory control period having sensory recovery period parameters comprising at least the duration of the recovery period, the sensory recovery period parameters determined by the at least one control unit by comparing the at least one performance metric and the at least one physiological metrics to predefined thresholds.

18. The system of claim 17, wherein the sensory recovery period parameters further comprise a second quantity of visual information, the second quantity of visual information being between one hundred percent and the first quantity of visual information.

19. The system of claim 17, wherein the training tasks comprise shooting at at least one target, and wherein the at least one performance metric comprises a number of target hits.

20. The system of claim 19, wherein the at least one physiological metric comprises balance data.
